(19) United States
(12) Patent Application Publication
(10) Pub. No.: US 2009/0231852 A1
(43) Pub. Date: Sep. 17, 2009

(54) POSITIONING ENCODING IN A LIGHT FIXTURE

(75) Inventors: Thomas Vinter, Beder (DK); Niels Jorgen Rasmussen, Egaa (DK)

Correspondence Address: ROBERTS MLOTKOWSKI SAFRAN & COLE, P.C.;Intellectual Property Department, P.O. Box 10064, MCLEAN, VA, 22102-8064, US

(73) Assignee: MARTIN PROFESSIONAL A/S, Aarhus N (DK)

(21) Appl. No.: 12/107,827

(22) Filed: Apr. 23, 2008

(30) Foreign Application Priority Data
Mar. 17, 2008 (DK) PA 2008 00409

(51) Int. Cl. F21V 23/00; H05B 37/02

(52) U.S. Cl. 362/276; 315/309

(57) ABSTRACT

A lighting fixture having at least one fixed element, to which fixed element controllable moving elements are rotatingly fastened, where one moving element has at least one light source. To automatically receive information concerning the orientation of lighting fixture and to achieve feed-forward regulation of cooling in the lighting unit the lighting fixture has an orientation sensor as the at least one the fixed element, which orientation sensor detects at least 3 orthogonal axes and transmits orientation signals to an internal processor in the lighting fixture, which processor calculates the actual orientation of the fixed elements. As a result, a computer that controls the lightning fixture knows the actual position of each component in the lightning fixture.

### BACKGROUND OF THE INVENTION

1. Field of the Invention

The present invention relates to a lighting fixture comprising at least one fixed element, to which fixed element controllable moving elements are rotating fastened, where one moving element comprises at least one light source, which light source generates a beam of light, which lighting fixture comprises at least one internal processor.

2. Description of Related Art

By operating light fixtures, it is well-known that these light fixtures can be placed in different positions. When a light fixture is placed in a rig, the position of the base is fixed. Often light fixtures are used for a show and are as such in operation for a short period of time and then the light fixtures are sent back to storage from where they are sent for the next show. By this way of operation, there are no rules for how a light fixture is positioned. Therefore, typical light fixtures are designed so that their cooling demand is independent on the position of the light fixture. This can lead to a situation where more cooling energy is used for operating blowing means than necessary.

From state of the art, position detectors are well-known as electronic integrated circuits which based on gravity can tell the actual position in relation to three orthogonal axes. These integrated circuits are known for different purposes such as changing the direction of an LCD display independent on how e.g. a mobile phone is orientated.

### SUMMARY OF THE INVENTION

It is the scope of the invention is to automatic receiving information concerning the orientation of lighting fixture. A further scope of the invention is to achieve feed-forward regulation of cooling means in the lighting unit.

This can be achieved by a lighting fixture as described in the preamble to claim 1 if modified if at least the fixed element comprises an orientation-sensor, which orientation-sensor detects at least 3 orthogonal axes, which sensor is transmitting orientation signals to an internal processor in the lighting fixture, which processor calculate the actual fixed elements orientation in respect to gravity.

Hereby, it can be achieved that the computer that controls the lightning fixture knows the actual position of each component in the lightning fixture independent of gravity. This information can be used in the head, e.g. for changing the text in a display always to be presented correctly upwards. The information about the actual orientation can result in a very fast start-up of a light fixture. Because the positions are well-known there is not need for turning e.g. pan or tilt into end position to reach a reset position. The actual position in relation to gravity can also be highly effective in predicting the cooling demand in the light fixture.

It is preferred that the lighting fixture comprises at least at least one controllable fan. By using a controllable fan it is possible to adjust the rotational speed of that fan and thereby the amount of air circulated in a light fixture independent of the actual position of a head.

The lighting fixture can comprise at least one thermo sensor, which thermo sensors are measuring internal temperature in the lighting fixture, which thermo sensors further measure ambient temperature, which thermo sensors transmit temperature data to the internal processor. By using an internal processor that cooperates with a number of thermo sensors in a lighting fixture, there will always be performed an effective feedback regulation. Combined with the position data, the regulation can be more effective.

The internal processor can receive position data from the moving elements. Depending on where the position detector is placed, positions detections from other components are necessary to achieve the best result. Only in this way, the actual position of a moving component can be well-known by the processor.

In a preferred embodiment for the invention the internal processor calculate cooling demand for the light fixture based on actual position of the moving elements of the lighting fixture and input from thermo-sensors. In a typical light fixture, there are a number of blowing means placed at different positions. All these blowing means are probably controlled by a processor. This processor can by actual position indication be programmed so that it works as a feed-forward regulator where also information form thermo sensors are used in the regulation, probably as a feedback system. By combining a feed forward regulation based on the actual position of the head combined with a feedback based on the actual measured temperature inside the head there can be achieved a highly effective thermal regulation in the light fixture.

The internal processor can predict a future cooling demand based on position and temperature data and based on the actual activity in the lighting fixture. Further, it is possible if a programme in the light fixture has knowledge of future activity it is also possible to use that known future activity as a feed forward signal for the regulation of the cooling demand.

The internal processor can also control the operation of at least one fan in the lighting fixture. It is preferred that the internal processor is able to control the air circulation in the light fixture. This can be achieved if at least one fan in the lighting fixture is controlled by the processor. In most embodiments for the invention, a number of fans will be controlled by the internal processor in order to not only adjust to the airflow, but in some situation also shift direction of the air circulation in the lighting fixture.

Further can the internal processor control both speed and direction of the fan output appropriate to cool desired areas. It is preferred that the processor has the total control over fans in the lighting fixture so that both speed and direction can be regulated. By performing this regulation, the power demand for the different fans in a light fixture might be reduced simply because fans are only operating if there is a direct demand for cooling.

The lighting fixture can comprise absolute encoding devices, which encoding devices are indicating the angular placement of a first moveable element in relation to the fixed element, where a further encoding devise measures the angular relative movement between a first moveable element and a second moveable element. If a position detector, e.g. is placed at a main circuit in the base of a light fixture in order to get information about the actual position of the head, it is necessary to measure the actual position of the pan and tilt of the head. This could effectively be performed it an absolute encoding device is picking up position indications.

The absolute encoding devices comprises a gearbox, which gearbox comprises a first input axle and a second internal axle, which first input axle is driving a first toothed timing wheel, which first toothed timing wheel is intermeshing with a second toothed timing wheel, which second toothed timing wheel rotates the second axle with a angular velocity different from the angular velocity of the first input axle. One possible way of producing an encoding device is using a gear box. Using this gear box several turns can be performed at the input shaft and the electronic signals from the gear box will still contain a perfect indication of the actual position.

The first and second axles comprises magnets at the axle ends, which magnets generates a magnetic field mostly perpendicular to the longitudinal direction of the axles, which magnets each facing a sensor PCB which sensor PCB transmit the signals from the sensors to the internal processor. By using magnetic detectors a very reliable detection can be performed. Dust or smoke has no influence on the measured signals.

### BRIEF DESCRIPTION OF THE DRAWINGS

FIG. 1 shows a system for rotating a head of a light fixture.

FIG. 2 shows an absolute encoding module.

FIG. 3 shows the same embodiment as FIG. 2, but seen from the backside.

### DETAILED DESCRIPTION OF THE INVENTION

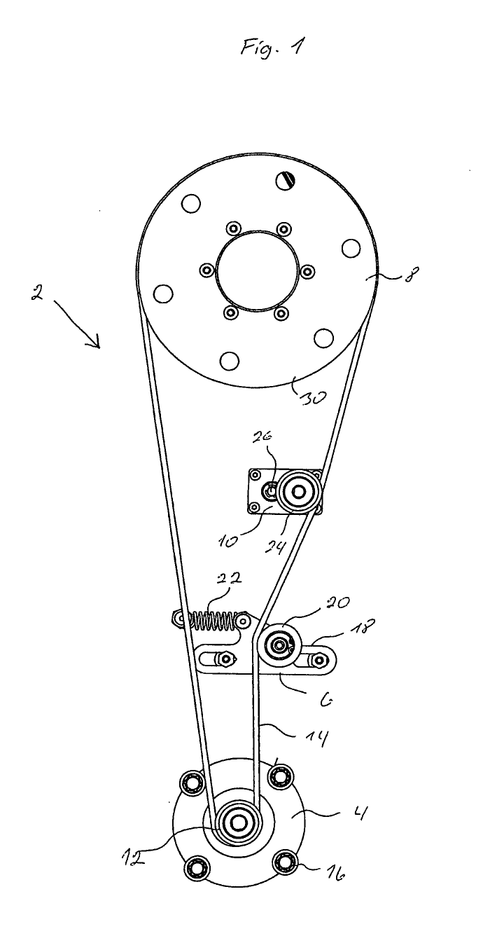

FIG. 1 shows a system 2 for rotating a head of a light fixture. A motor 4 comprises a driving wheel 12, which driving wheel drives a belt 14, which belt 14 is kept tight by a belt tighter 6. The belt tighter comprises a fixture 18 and a tighten wheel 20, which fixture 20 is under tension by a spring 22. An absolute encoding module 10 comprises an input wheel 24 driven by the belt 14. The input wheel 24 rotates a first axle, which first axle rotates a second axle 26 with a different speed. Further drives the belt 14 a wheel 8,30 connected to a head.

The actual position of the wheel 30 can be indicated by the absolute encoding module 10.

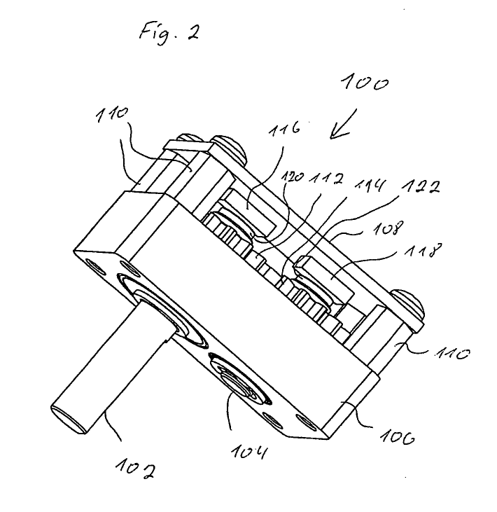

FIG. 2 shows an absolute encoding module 100 comprising an input axle 102 and a second axle 104. These axles 102,104 are supported by means of bearings inside a housing 106. An end plate 108 is by means of bolts 110 connected to the housing 106. The input shaft 102 is connected to a first toothed wheel 112 and the second shaft 104 is connected to tooth wheel 114. Placed at the end plate 108 is shown magnetic detecting devices 116 and 118. These magnetic detection devices 116,118 are cooperating with magnets 120 and 122 which are connected to the end of the shafts 102 and 104.

In operation, the rotation of the input shaft 102 will be indicated by the magnetic detector 116. But at the same time as the input shaft 102 starts rotating the toothed wheel 112 is interacting with the toothed wheel so that the shaft 104 is rotated as well. Because there is a difference in the number of tooth at the toothed wheel 112 and 114, the shaft 104 will rotate at a speed slower or faster than the shaft 102. These differences in velocity of the shafts 102,104 will result in a sufficient difference in the signals indicated by the magnetic detectors 116 and 118. Hereby an electronic microprocessor can achieve a highly accurate angular position of the shaft 102. This position will be highly accurate even if the shaft 102 is turned in several rotations in one or another direction which is sufficient for precise indication of the position in pan or tilt of a light fixture.

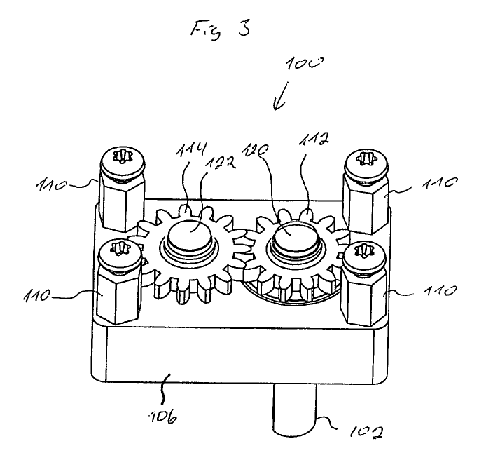

FIG. 3 shows the same embodiment as FIG. 2, but seen from the backside and the end plate and the magnetic detectors are removed. FIG. 3 shows the input shaft 102 placed in the housing 106. The bolts 110 are also indicated. The toothed wheels 112 and 114 are interfering with each other. The magnets 120 and 122 are also shown. In an alternative embodiment, it is possible to achieve mostly the same effect by using two axles which are interconnected by the same belt but where wheels on the rotating axles have different diameters. Instead of letting toothed wheels in interact; it is possible to let the wheels connected by e.g. a belt. In another embodiment where space maybe not sufficient, it is possible at an existing belt connected from a driving motor to a rotating element somewhere there is sufficient room to get in contact with that belt to use a wheel that is rotating a magnet in relation to a magnetic detector. Placing two of these detecting elements along the same belt and letting the wheels that have been driven by the belt having a different diameters, it is possible to achieve that effect that the magnetic detectors will deliver signals having different frequencies. It is to be understood that each detector could deliver a sinus signal. When two sinus signals having different frequency are compared very long time differences can occur before the same position of both sinus curves are achieved. Therefore rotating of the wheels can be performed for several rotations and there will still be a total position indication.

What is claimed is:

1. A lighting fixture comprising at least one fixed element, to which fixed element controllable moving elements are rotating fastened, where one moving element comprises at least one light source, which light source generates a beam of light, which lighting fixture comprises at least one internal processor, where at least the fixed element comprises an orientation-sensor, which orientation-sensor detects at least 3 orthogonal axes, which orientation-sensor is transmitting orientation signals to an internal processor in the lighting fixture, which processor calculate the actual fixed elements orientation in respect to gravity.

2. A lighting fixture according to claim 1, wherein the lighting fixture comprises at least at least one controllable fan.

3. A lighting fixture according to claim 2, wherein the lighting fixture comprises at least one thermo sensor, which thermo sensors are measuring internal temperature in the lighting fixture, which thermo sensors further measure ambient temperature, which thermo sensors transmit temperature data to the internal processor.

4. A lighting fixture according to claims 3, wherein the internal processor receives position data from the moving elements

5. A lighting fixture according to claim 4, wherein the internal processor calculate cooling demand for the light fixture based on actual position of the moving elements of the lighting fixture and input from thermo-sensors.

6. A lighting fixture according to claim 5, wherein the internal processor predict a future cooling demand based on position and temperature data and based on the actual activity in the lighting fixture.

7. A lighting fixture according to claim 6, wherein the internal processor control the operation of at least one fan in the lighting fixture.

8. A lighting fixture according to claim 7, wherein the internal processor controls both speed and direction of the fan output appropriate to cool desired areas.

9. A lighting fixture according to claim 1, wherein the lighting fixture comprises absolute encoding devices, which encoding devices are indicating the angular placement of a first moveable element in relation to the fixed element, where a further encoding devise measures the angular relative movement between a first moveable element and a second moveable element.

10. A lighting fixture according to claim 9, wherein the absolute encoding devices comprises a gearbox, which gearbox comprises a first input axle and a second internal axle, which first input axle is driving a first toothed timing wheel, which first toothed timing wheel is intermeshing with a second toothed timing wheel, which second toothed timing wheel rotates the second axle with a angular velocity different from the angular velocity of the first input axle.

11. A lighting fixture according to claim 9, wherein the first and second axles comprises magnets at the axle ends, which magnets generates a magnetic field mostly perpendicular to the longitudinal direction of the axles, which magnets each facing a sensor PCB which sensor PCB transmit the signals from the sensors to the internal processor.
